(19) United States
(12) Patent Application Publication
(10) Pub. No.: US 2026/0197200 A1
(43) Pub. Date: Jul. 9, 2026

(54) CHANNEL STATE ESTIMATION

(71) Applicant: Nokia Solutions and Networks Oy, Espoo (FI)

(72) Inventors: Yejian CHEN, Stuttgart (DE); Thorsten WILD, Stuttgart (DE); Jafar MOHAMMADI, Munich (DE); Stefan WESEMANN, Stuttgart (DE)

(21) Appl. No.: 19/131,847

(22) PCT Filed: Nov. 22, 2022
(86) PCT No.: PCT/EP2022/082771

§ 371 Date: May 21, 2025

(51) Int. Cl. H04L 25/02; H04B 7/06

(52) U.S. Cl. CPC H04L 25/0202; H04B 7/0639

(57) ABSTRACT

A method comprising: receiving, from a user equipment, UE, by a base station, via a radio channel, precoded Demodulated Reference Signals, DMRSs; receiving, from the UE by the base station, via the radio channel, a first UE-specific un-precoded Sounding Reference Signal, SRS and a second UE-specific un-precoded SRS spaced in time by a scheduled SRS time period; receiving, from the UE by the base station, via the radio channel and during the scheduled SRS period between the first and second UE-specific un-precoded SRS, at least one UE-specific un-precoded Demodulated Reference Signal, DMRS; generating a channel estimation for the radio channel based on the at least one precoded DMRS and the at least one UE-specific un-precoded DMRS.

### TECHNICAL FIELD

Various example embodiments relate generally to apparatuses and method for channel state estimation.

### BACKGROUND

SRS (Sounding Reference Signal) and DMRS (Demodulation Reference Signal) are reference signals, which are scheduled with respective periods in uplink and used for channel estimation purposes. The base station estimates the channel based on the uplink SRS received from the User Equipment (UE) and configure a precoding matrix.

The base station may configure a precoding matrix, e.g. in an uplink grant message. Precoding is used for multi-layer transmission in order to maximize the throughput of a multi-antenna system in which both the receiver and transmitter have multiple antennas. Precoding is a generalized scheme used to support multi-layer transmission in a MIMO (Multiple Input Multiple Output) system. The precoding matrix maps the layers to the antenna ports, e.g. with at most one layer being mapped to each antenna port. Using precoding, multiple streams can be transmitted from the transmit antennas with channel-dependent weighting per antenna such that the throughput is maximized at the transmitter output.

The precoding matrices are deployed for transmission of precoded DMRS and data transmission, and computed, based on the uplink channel estimates performed using un-precoded SRS, when multi-layer signals are transmitted by a UE.

On one side, SRS with long periodicity may be preferred, for the sake of being able to free radio resources to support many active UEs. On the other side, the channel estimates based on uplink SRS can be quickly outdated, especially in high-speed scenario, which makes the uplink precoding inaccurate.

Increasing the periodicity of SRS or DMRS or the on-demand sending of SRS may be possible but the tuning of the periodicity in case of changes of mobility is not simple and could lead into waste of resources.

In addition, increasing the density of DMRS in time domain (e.g. by using consecutive symbols) may improve the quality of the interpolation performed to generate DMRS-based channel estimates. Nevertheless, this does not help monitoring the sounding channel and generation of SRS-based channel estimates if multi-layer DMRS is exploited.

### SUMMARY

The scope of protection is set out by the independent claims. The embodiments, examples and features, if any, described in this specification that do not fall under the scope of the protection are to be interpreted as examples useful for understanding the various embodiments or examples that fall under the scope of protection.

According to a first aspect, a method comprises: receiving, from a user equipment, UE, by a base station, via a radio channel, precoded Demodulated Reference Signals, DMRSs; receiving, from the UE by the base station, via the radio channel, a first UE-specific un-precoded Sounding Reference Signal, SRS and a second UE-specific un-precoded SRS spaced in time by a scheduled SRS time period; receiving, from the UE by the base station, via the radio channel and during the scheduled SRS period between the first and second UE-specific un-precoded SRS, at least one UE-specific un-precoded Demodulated Reference Signal, DMRS; generating a channel estimation for the radio channel based on the at least one precoded DMRS and the at least one UE-specific un-precoded DMRS.

The DMRSs and the at least one UE-specific un-precoded DMRS may be received during respective distinct time slots spaced in time with a same period. Generating the channel estimation may include generating a precoded channel estimation and an un-precoded channel estimation. Generating the channel estimation may be performed by a Machine Learning, ML, based model configured to generate the channel estimation using as inputs the precoded DMRSs and the at least one UE-specific un-precoded DMRS. The ML based model may be a neural network. Generating the channel estimation may be performed without a priori information on the precoding matrix used by the UE for generating the precoded DMRSs. The method according to the first aspect may comprise: estimating a precoding matrix used by the UE based on the precoded channel estimation and the un-precoded channel estimation. The estimated precoding matrix may be selected in a finite set of candidate precoding matrices and corresponds to a candidate precoding matrix that minimizes the difference between the precoded channel estimation and a channel estimation resulting from the application of the concerned candidate precoding matrix to the un-precoded channel estimation.

According to another aspect, an apparatus comprises means for performing a method comprising: receiving, from a user equipment, UE, by a base station, via a radio channel, precoded Demodulated Reference Signals, DMRSs; receiving, from the UE by the base station, via the radio channel, a first UE-specific un-precoded Sounding Reference Signal, SRS and a second UE-specific un-precoded SRS spaced in time by a scheduled SRS time period; receiving, from the UE by the base station, via the radio channel and during the scheduled SRS period between the first and second UE-specific un-precoded SRS, at least one UE-specific un-precoded Demodulated Reference Signal, DMRS; generating a channel estimation for the radio channel based on the at least one precoded DMRS and the at least one UE-specific un-precoded DMRS.

The apparatus may comprise means for performing one or more or all steps of the method according to the first aspect. The means may include circuitry configured to perform one or more or all steps of a method according to the first aspect. The means may include at least one processor and at least one memory storing instructions that, when executed by the at least one processor, cause the apparatus to perform one or more or all steps of a method according to the first aspect.

According to another aspect, an apparatus comprise at least one processor and at least one memory storing instructions that, when executed by the at least one processor, cause the apparatus to perform: receiving, from a user equipment, UE, by a base station, via a radio channel, precoded Demodulated Reference Signals, DMRSs; receiving, from the UE by the base station, via the radio channel, a first UE-specific un-precoded Sounding Reference Signal, SRS and a second UE-specific un-precoded SRS spaced in time by a scheduled SRS time period; receiving, from the UE by the base station, via the radio channel and during the scheduled SRS period between the first and second UE-specific un-precoded SRS, at least one UE-specific un-precoded Demodulated Reference Signal, DMRS; generating a channel estimation for the radio channel based on the at least one precoded DMRS and the at least one UE-specific un-precoded DMRS.

The instructions, when executed by the at least one processor, may cause the apparatus to perform one or more or all steps of a method according to the first aspect.

According to another aspect, a computer program comprises instructions for causing an apparatus to perform a method comprising: receiving, from a user equipment, UE, by a base station, via a radio channel, precoded Demodulated Reference Signals, DMRSs; receiving, from the UE by the base station, via the radio channel, a first UE-specific un-precoded Sounding Reference Signal, SRS and a second UE-specific un-precoded SRS spaced in time by a scheduled SRS time period; receiving, from the UE by the base station, via the radio channel and during the scheduled SRS period between the first and second UE-specific un-precoded SRS, at least one UE-specific un-precoded Demodulated Reference Signal, DMRS; generating a channel estimation for the radio channel based on the at least one precoded DMRS and the at least one UE-specific un-precoded DMRS.

The instructions may cause the apparatus to perform one or more or all steps of a method according to the first aspect.

According to another aspect, a non-transitory computer readable medium comprises program instructions stored thereon for performing at least the following: receiving, from a user equipment, UE, by a base station, via a radio channel, precoded Demodulated Reference Signals, DMRSs; receiving, from the UE by the base station, via the radio channel, a first UE-specific un-precoded Sounding Reference Signal, SRS and a second UE-specific un-precoded SRS spaced in time by a scheduled SRS time period; receiving, from the UE by the base station, via the radio channel and during the scheduled SRS period between the first and second UE-specific un-precoded SRS, at least one UE-specific un-precoded Demodulated Reference Signal, DMRS; generating a channel estimation for the radio channel based on the at least one precoded DMRS and the at least one UE-specific un-precoded DMRS.

The program instructions may cause the apparatus to perform one or more or all steps of a method according to the first aspect.

According to a second aspect, a method comprises: sending, by a user equipment, UE, to a base station, via a radio channel, at least one precoded Demodulated Reference Signal, DMRS; sending, by the UE to the base station, via the radio channel, a first UE-specific un-precoded Sounding Reference Signals, SRS and a second UE-specific un-precoded SRS spaced in time by a scheduled SRS time period; sending, by the UE to the base station, via the radio channel, during the scheduled SRS period between the first and second UE-specific un-precoded SRS, at least one UE-specific un-precoded Demodulated Reference Signal, DMRS.

The method according to the second aspect may comprise: detecting a change of channel condition at a current time step; adjusting a precoding matrix configured by the base station to adapt to the detected change; using the adjusted precoding matrix to generate a precoded DMRS for a next time step; informing the base station of a change of precoding matrix. The method according to the second aspect may comprise: detecting channel conditions changes for the radio channel; deciding dynamically whether to send or not the at least one UE-specific un-precoded DMRS based on a frequency of the detected channel conditions changes.

According to another aspect, an apparatus comprises means for performing a method comprising: sending, by a user equipment, UE, to a base station, via a radio channel, at least one precoded Demodulated Reference Signal, DMRS; sending, by the UE to the base station, via the radio channel, a first UE-specific un-precoded Sounding Reference Signals, SRS and a second UE-specific un-precoded SRS spaced in time by a scheduled SRS time period; sending, by the UE to the base station, via the radio channel, during the scheduled SRS period between the first and second UE-specific un-precoded SRS, at least one UE-specific un-precoded Demodulated Reference Signal, DMRS.

The apparatus may comprise means for performing one or more or all steps of the method according to the second aspect. The means may include circuitry configured to perform one or more or all steps of a method according to the second aspect. The means may include at least one processor and at least one memory storing instructions that, when executed by the at least one processor, cause the apparatus to perform one or more or all steps of a method according to the second aspect.

According to another aspect, an apparatus comprises at least one processor and at least one memory storing instructions that, when executed by the at least one processor, cause the apparatus to perform: sending, by a user equipment, UE, to a base station, via a radio channel, at least one precoded Demodulated Reference Signal, DMRS; sending, by the UE to the base station, via the radio channel, a first UE-specific un-precoded Sounding Reference Signals, SRS and a second UE-specific un-precoded SRS spaced in time by a scheduled SRS time period; sending, by the UE to the base station, via the radio channel, during the scheduled SRS period between the first and second UE-specific un-precoded SRS, at least one UE-specific un-precoded Demodulated Reference Signal, DMRS.

The instructions, when executed by the at least one processor, may cause the apparatus to perform one or more or all steps of a method according to the second aspect.

According to another aspect, a computer program comprises instructions that, when executed by an apparatus, cause the apparatus to perform: sending, by a user equipment, UE, to a base station, via a radio channel, at least one precoded Demodulated Reference Signal, DMRS; sending, by the UE to the base station, via the radio channel, a first UE-specific un-precoded Sounding Reference Signals, SRS and a second UE-specific un-precoded SRS spaced in time by a scheduled SRS time period; sending, by the UE to the base station, via the radio channel, during the scheduled SRS period between the first and second UE-specific un-precoded SRS, at least one UE-specific un-precoded Demodulated Reference Signal, DMRS.

The instructions may cause the apparatus to perform one or more or all steps of a method according to the second aspect.

According to another aspect, a non-transitory computer readable medium comprises program instructions stored thereon for causing an apparatus to perform at least the following: sending, by a user equipment, UE, to a base station, via a radio channel, at least one precoded Demodulated Reference Signal, DMRS; sending, by the UE to the base station, via the radio channel, a first UE-specific un-precoded Sounding Reference Signals, SRS and a second UE-specific un-precoded SRS spaced in time by a scheduled SRS time period; sending, by the UE to the base station, via the radio channel, during the scheduled SRS period between the first and second UE-specific un-precoded SRS, at least one UE-specific un-precoded Demodulated Reference Signal, DMRS.

The program instructions may cause the apparatus to perform one or more or all steps of a method according to the second aspect.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 illustrates the use of a time and frequency resources for transmission of reference signals according to an example.

FIG. 2 illustrates the use of a time and frequency resources for transmission of reference signals according to an example.

FIG. 3 illustrates the use of a time and frequency resources according to an example.

FIG. 4 illustrates aspects of signal precoding according to an example.

FIG. 5 is a block diagram of a neural network for channel estimation according to an example.

FIG. 6 is a block diagram of a ML-based model for channel estimation according to an example.

FIG. 7 illustrates aspects of training of a ML-based model for channel estimation according to an example.

FIG. 8 illustrates aspects of training of a ML-based model for channel estimation according to an example.

FIGS. 9A-9B show curves illustrating performance of a method for channel estimation according to an example.

FIG. 10A show a flowchart of a method for channel estimation according to an example.

FIG. 10B show a flowchart of a method for channel sounding according to an example.

FIG. 11 is a block diagram illustrating an exemplary hardware structure of an apparatus according to an example.

It should be noted that these drawings are intended to illustrate various aspects of devices, methods and structures used in example embodiments described herein. The use of similar or identical reference numbers in the various drawings is intended to indicate the presence of a similar or identical element or feature.

### DETAILED DESCRIPTION

Detailed example embodiments are disclosed herein. However, specific structural and/or functional details disclosed herein are merely representative for purposes of describing example embodiments and providing a clear understanding of the underlying principles. However these example embodiments may be practiced without these specific details. These example embodiments may be embodied in many alternate forms, with various modifications, and should not be construed as limited to only the embodiments set forth herein. In addition, the figures and descriptions may have been simplified to illustrate elements and/or aspects that are relevant for a clear understanding of the present invention, while eliminating, for purposes of clarity, many other elements that may be well known in the art or not relevant for the understanding of the invention.

One or more example embodiments describe methods for channel estimation and channel sounding.

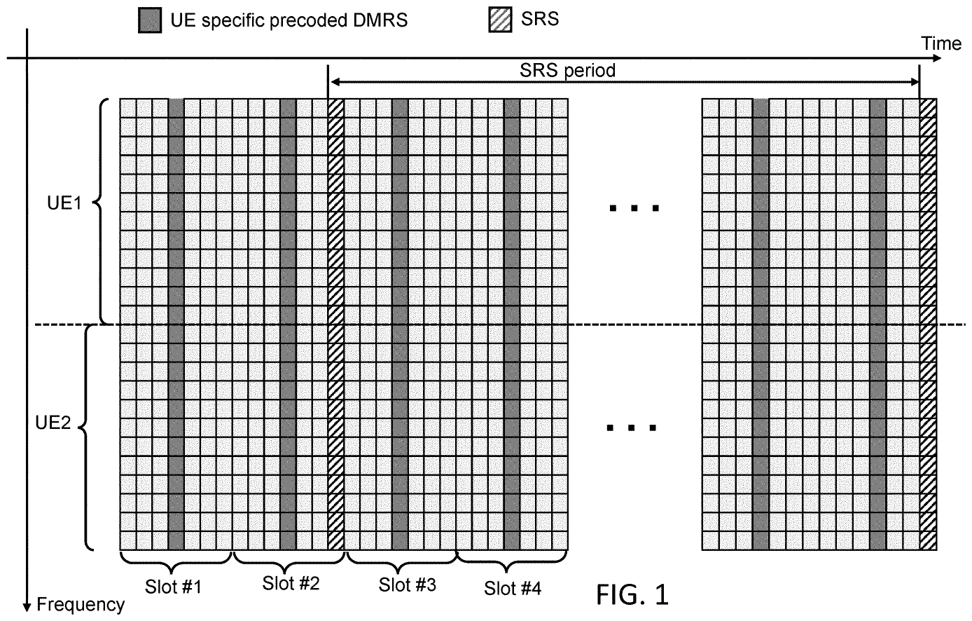

FIG. 1 shows the use of a resource grid for uplink transmission of reference signals over time when a SRS periodicity is configured.

Each UE (UE1, UE2) uses UE-specific resources to send DMRS signals and SRS signals. As shown in this figure, a precoded DMRS signal is sent for each time slot #1, #2, #3, etc (a time slot of 0.5 ms) while for the un-precoded SRS a SRS period for sending un-precoded SRS is configured by a base station. The SRS period may have values between 2.5 ms and 320 ms typically (e.g. 2.5, 10, 20, 40, 80, 160, 320 ms). As illustrated by this figure, if the configured SRS period is large, the channel estimates based on uplink SRS can be quickly outdated, especially in high-speed scenario, which makes the uplink precoding inaccurate.

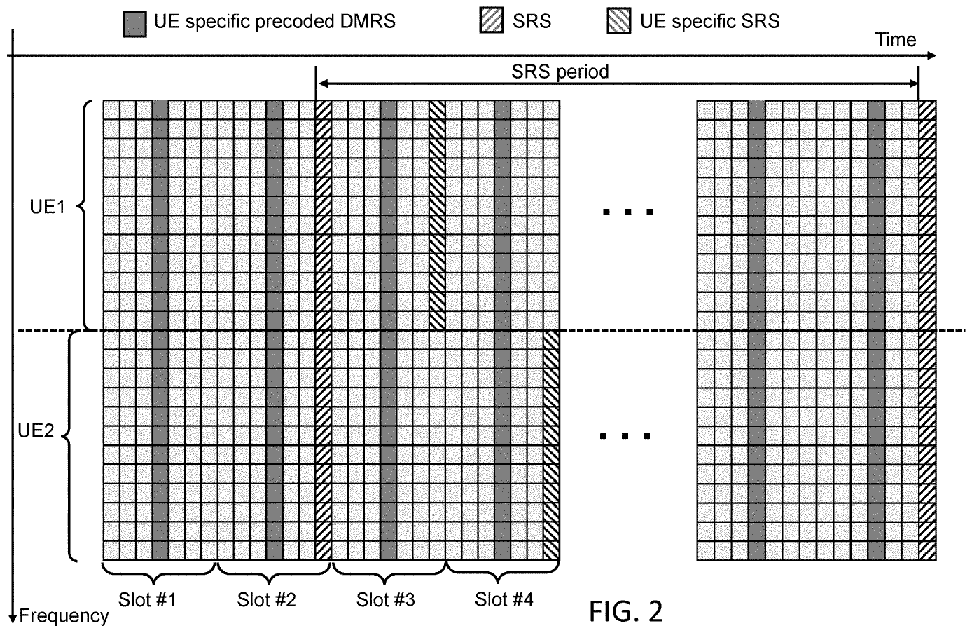

FIG. 2 shows the use of a resource grid for uplink transmission of reference signals over time for on-demand SRS mode.

This on-demand SRS mode allows to avoid the outdating of the SRS-based channel estimates, by requesting the transmission of additional user-specific SRS within the SRS period. Nevertheless, this is performed at the cost of loss of radio resources. For instance, additional overhead will be spent to schedule such user-specific SRS, and the throughput in corresponding PRBs will be reduced by 16.67%, where the user-specific SRS need to be transmitted.

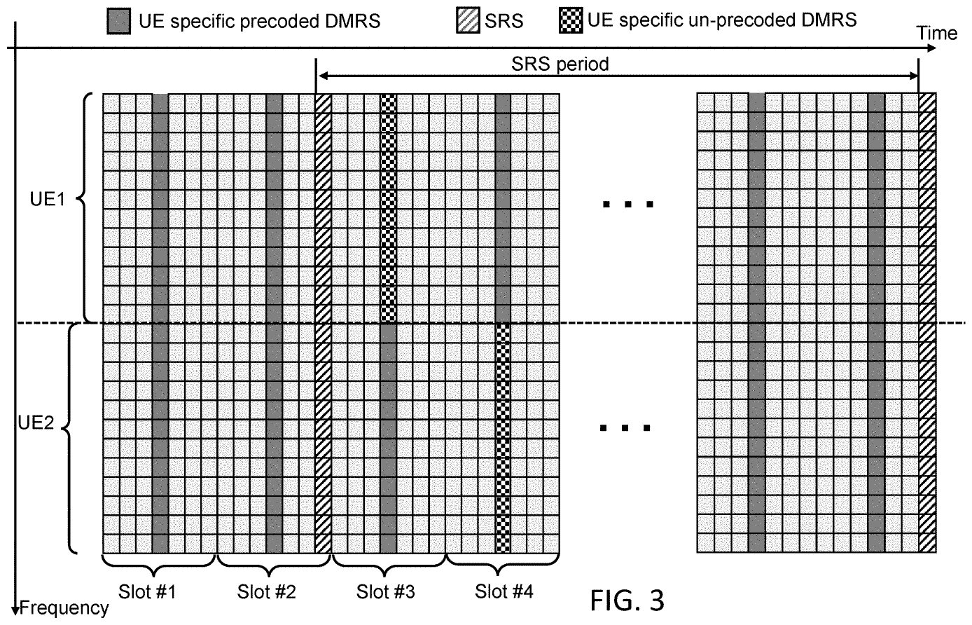

FIG. 3 shows the use of a resource grid for uplink transmission of reference signals over time that is based on the use of user-specific un-precoded DMRS signals.

In this scenario, one or more un-precoded DMRSs are transmitted between two consecutive SRS transmissions, e.g. within the configured SRS period, to be able to estimate the un-precoded channel state. The expression “un-precoded channel state” refers herein to the channel state estimated based on un-precoded signal(s). In this context, channel sounding monitoring include estimating the un-precoded channel state based on the SRS.

The one or more un-precoded DMRSs may be inserted among precoded DMRSs. The period of such un-precoded DMRS can be scenario-specifically adjustable. Namely, the period may be determined based on multiple periodicity patterns used by the UE to be adapted to a given scenario, e.g. high-speed case where the UE is moving at high speed. For example, a UE may insert un-precoded DMRS(s) in conjunction with exploiting self-optimized precoding matrix for the rest precoded DMRS(s), after replacing the pre-allocated precoding matrix. The periodicity of the un-precoded DMRSs may depend on sporadic channel outdating, which can be detected by the UE much earlier than by the base station.

The one or more un-precoded DMRSs are UE specific un-precoded DMRSs that may be triggered by the UE, based on a decision taken by the UE. One or more trigger conditions may be used to decide whether or not to trigger the sending of one or more un-precoded DMRSs. The scenario with un-precoded DMRS(s) may be triggered for example when the SRS period is above a threshold and/or based on detection of fast channel condition changes. Also the number and/or periodicity of the un-precoded DMRSs may be adjusted in dependence of the configured SRS period and/or a frequency of the detected channel condition changes.

By doing so, un-precoded DMRSs, adjustable in time domain, are introduced to delegate the functionality of channel sounding monitoring from SRS to DMRS. The other DMRS signals are still precoded in a conventional manner to enable multi-layer transmission. Although there seems to be a slight modification in the scenario of FIG. 3, the difference to FIG. 2 is enormous. Firstly, the throughput will not be impacted by introducing un-precoded DMRSs at all because, in contrast with additional SRS transmission, no resource has to be scheduled, which is originally scheduled for data transmission. Secondly, the additional overhead related to un-precoded DMRS(s) will not exceed that of UE specific SRS because the indicator for un-precoded DMRS(s) will be just 1 bit, e.g. “1” for activated and “0” for inactivated.

Using un-precoded DMRS(s) is an approach to possibly maintain the current throughput and requires much less overhead in scheduling un-precoded DMRS(s) than scheduling user-specific SRS. Based on the comparison of the examples of FIG. 2 and FIG. 3, with and without additional SRS, there is a loss of 1−5/6=16.67%. The frame-wise loss depends on how frequently the user-specific SRS is exploited.

Also, by assuming that the relatively long SRS periodicity for uplink is a potential trend for future 6G communication networks, this scenario with un-precoded DMRS(s) appears to be relevant for such communication networks.

It is to be noted that un-precoded signal may mean that no precoding at all is performed and no precoding matrix is used for generating the sounding signals to be transmitted through the radio channel. Un-precoded signal may also mean that the precoding matrix is the identity matrix and the precoding operation performed by the UE amounts to the application of a spatial filter selected by the UE (and not explicitly controlled by the network).

Further, an ML-based approach may be used at base station side for estimating the precoded and un-precoded channel states using a ML-based model, referred to herein as the ML-based channel estimator or ML-based model for channel estimation. The ML-based model may be based for example on a pre-trained Neural Network (NN). Once the NN is trained for adapting to sufficient precoded and un-precoded observations, such a ML-based approach does not require any knowledge of precoding matrix used by the UE, nor of the codebook from which the precoding matrix may be selected in the practical inference stage.

This ML-based model for channel estimation may be configured to generate a precoded channel estimation and an un-precoded channel estimation. This ML-based model for channel estimation may be configured to generate the channel estimations using as inputs one or more precoded DMRSs and/or the at least one UE-specific un-precoded DMRS. The un-precoded channel estimation may be generated by the ML-based model without the knowledge of the precoding matrix used for the precoded DMRS(s). This ML-based model performs time-domain estimation from the input at least one precoded DMRS and at least one un-precoded DMRS. By exploiting the un-precoded DMRS(s) the base station can also monitor the subchannels at a given time step and adjust the precoding matrix for the following time slots.

Also the ML-based model may be used to support the scenario of both FIG. 2 and FIG. 3, with precoded DMRSs and on-demand SRSs (FIG. 2) or with precoded DMRSs and un-precoded DMRSs (FIG. 3). Especially, this ML-based channel estimator exploits not only the estimation gain in time domain, but also the spatial gain through spatial domain with respect to multi-layer signals transmitted via different transmit antennas (compared to the signal quality that may be obtained with a single antenna), which can guarantee robust performance at low Signal-to-Noise Ratio (SNR).

The ML-model may be based on a trained neural network (NN). The ML-model may be trained to be able to compute at inference time based on one or more precoded DMRSs and one or more UE-specific un-precoded DMRS a channel estimation weighting matrix. The channel estimation weighting matrix is then used to generate precoded and un-precoded channel estimates.

This ML-based approach is relevant for cases with codebook as well as cases in which non-codebook based precoder design is used and the UE can flexibly exploit self-optimized precoding matrix. Both in codebook-based and non-codebook-based precoding design, the estimation of un-precoded channel states cannot be performed based on precoded DMRS straightforwardly, if the precoding matrix is unknown at the base station. Therefore the ML-based model based on one or more un-precoded DMRSs that works without the knowledge of the precoding matrix used for the precoded DMRSs appears to be relevant for these situations.

Also the precoding matrix may be estimated for these precoding schemes, whether a codebook is used or not. The estimated precoding matrix may be searched in a codebook or in another finite set of precoding matrices that covers a search space.

The estimated precoding matrix may be, among the searched set of precoding matrices, the precoding matrix minimizes the difference between the precoded channel estimation and a channel estimation resulting from the application of the concerned precoding matrix to the un-precoded channel estimation.

The approach disclosed herein may be implemented for radio telecommunication systems, including a fifth generation (5G) network or 6G network. Prior or subsequent generations of radio telecommunication systems may be concerned by the methods and apparatuses disclosed herein.

Several aspects with now be described in details.

Aspects disclosed herein concern a method for channel estimation performed by an apparatus on access node side. An access node may be any type of base station (eNB, gNB, gNB-DU, gNB-CU, etc). At least part of the functionalities of the access node may also be carried out by a network entity (like a network node, a server, a host device, a host system) which is operably coupled to a transceiver (such as a remote radio head for example) and which may include other functions (such as an OAM function or another network function that may be used for implementing features in a NWDAF, Network Data Analytics Function, etc).

Aspects disclosed herein concern a method for channel sounding performed by an apparatus on UE side. A user equipment, UE, (or user terminal, user device) may refer to a computing device that includes wireless mobile communication devices operating with or without a subscriber identification module (SIM), including, but not limited to, the following types of devices: a mobile station (MS), a mobile phone, a radio cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples.

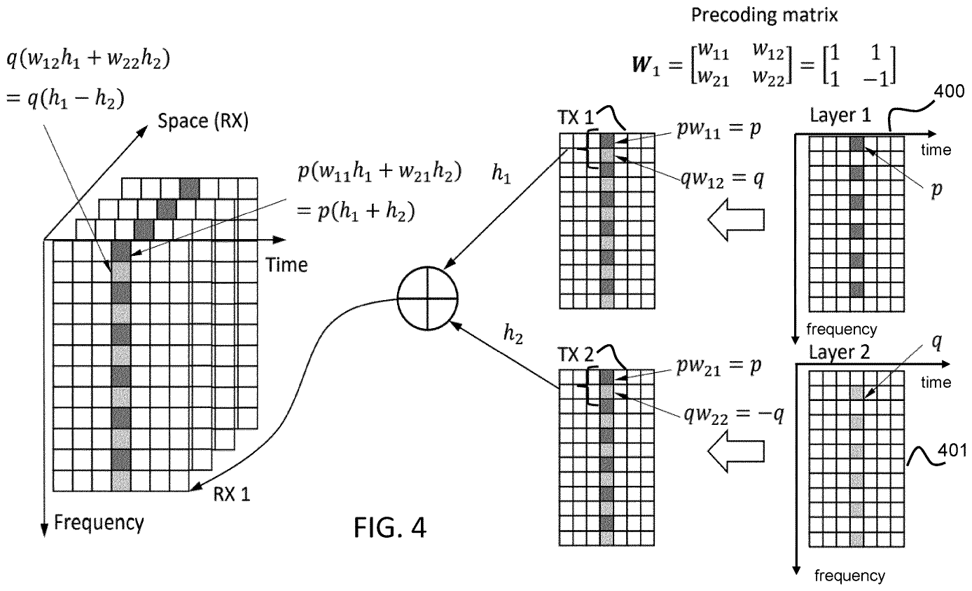

FIG. 4 illustrates without loss of generality how the multi-layer DMRS pilots (and likewise the user data) p and q are precoded and transmitted to the base station (BS) by a UE UE1. Here each DMRS pilot p and q are mapped to a respective layer: in this example the pilot p is mapped to layer 1 (400) and the pilot q is mapped to layer 2 (401). Each layer is represented as a 2D matrix of complex signals (defined in I/Q plan corresponding to a constellation plan) per time steps and frequency carriers. Each 2D matrix (400, 401) is weighted by a precoding matrix

$${W}_{1} = [ \begin{matrix}{w}_{11} & {w}_{12} \\ {w}_{21} & {w}_{22}\end{matrix} ] = [ \begin{matrix}1 & 1 \\ 1 & - 1\end{matrix} ]$$

to generate two 2D matrices TX1, TX2 of complex signals (per time step and frequency carriers) to be transmitted through uplink channel using the subchannels h₁ and h₂ used respectively by two distinct antennas of the transmitter.

From the viewpoint of the BS, the detected signals (in the example of FIG. 4, the received signals are the noisy observations of p (h₁+h₂) and q (h₁−h₂), which are a linear combination of the two subchannels h₁ and h₂, weighted by the precoding matrix W₁.

Here p and q are DMRS pilots (that can have arbitrary values under pre-defined power constraint) known by the base station and the base station removes the known DMRS pilots p and q before any further operations.

When the precoding matrix is full rank, namely invertible, the channel response (corresponding to h₁ and h₂) can be determined with linear (matrix) operation. Basically, with the knowledge of precoding matrix, the BS can estimate the subchannels h₁ and h₂ from the received noisy signal observations of p (h₁+h₂) and q (h₁−h₂).

The BS can estimate h₁ and h₂ using the reverse precoding matrix as follows:

$$[ \begin{matrix}{\hat{h}}_{1} \\ {\hat{h}}_{2}\end{matrix} ] = {W}_{1}^{- 1} [ \begin{matrix}{h}_{1} + {h}_{2} + {z}_{p} \\ {h}_{1} - {h}_{2} + {z}_{q}\end{matrix} ] = [ \begin{matrix}{h}_{1} + 0.5 ( {z}_{p} + {z}_{q )} \\ {h}_{2} + 0.5 ( {z}_{p} + {z}_{q )}\end{matrix} ]$$

The estimation of h₁ and h₂ is important because such weighted signals are configured to optimize the uplink effective channel gain. Any outdated estimation of h₁ and h₂ can cause a mismatch to the precoding and can thus introduce performance loss.

Non-codebook-based precoding may be used. For example, a UE may be configured to detect the mismatching of the precoding by itself, and may spontaneously compute a precoding matrix, which does not exist in the codebook to fully exploit the uplink spatial gain. If the knowledge of the precoding matrix is not available at the BS, the un-precoded subchannels h₁ and h₂ cannot be determined based on precoded DMRS(s) in such situation.

The use of un-precoded DMRS(s) allows to monitor and sound the radio channel and determine h₁ and h₂. For example, UE-specific un-precoded DMRS(s) amounts to exploit a precoding matrix equal to the identity matrix

$${W}_{0} = [ \begin{matrix}1 & 0 \\ 0 & 1\end{matrix} ] ,$$

so that the uplink channel responses h₁ and h₂ are explicitly separated at the BS and can be determined.

The transmission of DMRS is always linked to a PUSCH transmission (or PUCCH), which in turn can just be scheduled, if the UE has some data to transmit. In such data traffic, user-specific un-precoded DMRS(s) can be adjustably inserted in time domain, depending the user's channel characteristic, e.g. with significantly high selectivity due to high speed. One or more user-specific un-precoded DMRSs may be transmitted between two precoded DMRSs, for example such that one DMRS is received per a given time period, whether an un-precoded DMRS or a precoded DMRS.

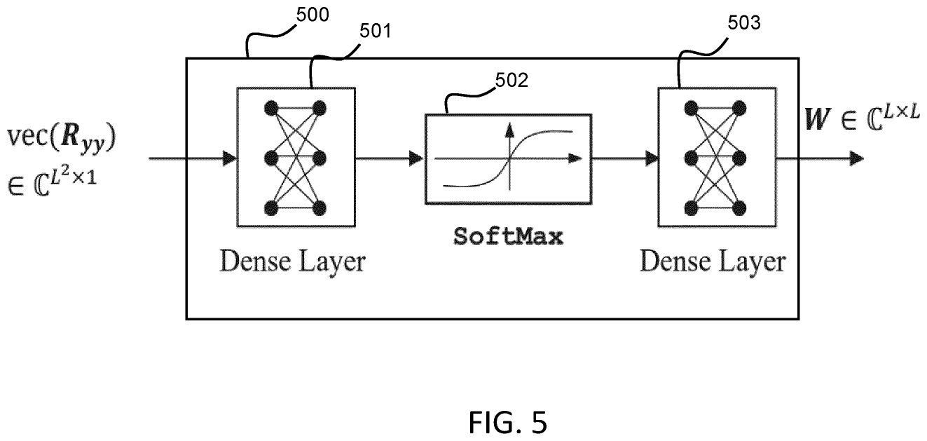

FIG. 5 shows an example neural network that may be used included in an ML-based model for channel estimation. In this example the neural network is a two-layers Dense Neural Network (DNN) 500 based channel estimator. The two-layers DNN include a first dense layer 501, followed by an activation function 502 (e.g. the softmax activation function), itself followed by a second dense layer 503. This ML-based model is used to exploit jointly precoded and un-precoded DMRS signals for channel estimation.

This neural network 500 is adapted to deliver near genie-aided Minimum Mean Square Error (MMSE) channel estimation for an observation y=h+z, where y, h and z are all vectors, if the sample covariance matrix R_{yy} can be obtained at a training stage. Here z represents the channel noise, h is the channel vector after equalizing the DMRS pilot corresponding to the signals sent by the UE and y is the observation vector corresponding to the signals received by the BS.

The channel noise is here modeled as an additive noise and may be an Additive White Gaussian Noise (AWGN). The additive noise may for example have a uniform SNR distribution from −20 dB to 20 dB, assumed for the training stage.

This neural network 500 is adapted to receive an input vector, noted vec(R_{yy}), where the operator vec (A) is configured to stack all column vectors of a L by L matrix A to a single column vector, where L denotes the dimension of the matrix A. In the context of channel estimation, after equalizing the DMRS pilots received by the BS, the input (column) vector y is generated, converted to a sample covariance matrix R_{yy} and then feed to the neural network 500 after vec-operation vec(R_{yy}).

The output of the neural network 500 is a L by L matrix W, referred to herein as the channel estimation weighting matrix, which is used for generating channel estimates. The matrix W includes weights for estimating the channel linearity and generating the channel estimates (also referred to herein as the channel estimations): the channel estimates can be linearly generated by applying the channel estimation weighting matrix to the observation vector.

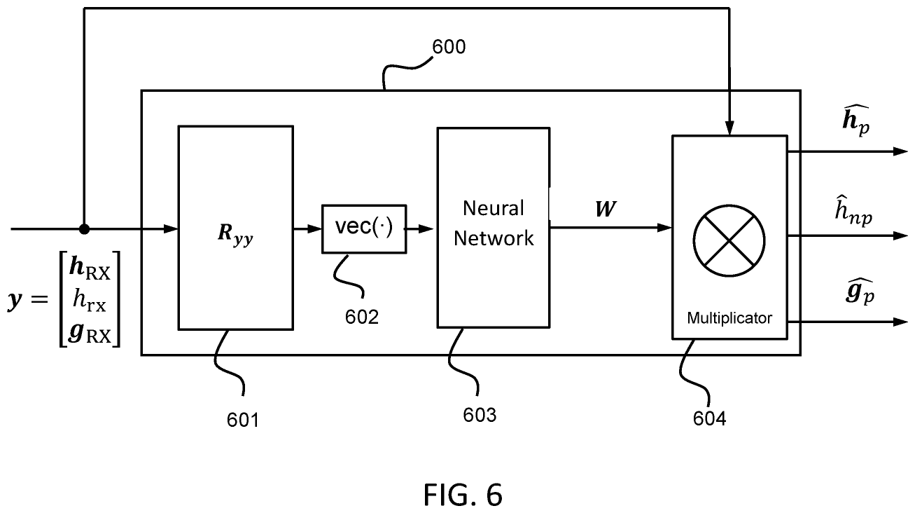

FIG. 6 illustrates aspects of an example of ML-based model 600 using jointly with noisy precoded and un-precoded DMRS observations and including a neural network 603 that may be a DNN 500 as disclosed by reference to FIG. 5.

We assume in this example that Wₓ is the precoding matrix of a user equipment UE1. Here

$${W}_{x} = [ \begin{matrix}{w}_{11} & {w}_{12} \\ {w}_{21} & {w}_{22}\end{matrix} ] = [ \begin{matrix}1 & 1 \\ 1 & - 1\end{matrix} ]$$

where w₁₁, w₁₂, w₂₁ and w₂₂ are the precoded weights.

A first vector hₚ that denotes the non-noisy observation at time steps k−1 to k−L and corresponds to the precoded channel response that depends on the precoded weights at time step k−1 to k−L is generated, where k stands for the time index.

$${h}_{p} = [ \begin{matrix}{w}_{11} {h}_{1} [ k - 3 ] + {w}_{21} {h}_{2} [ k - 3 ] \\ {w}_{11} {h}_{1} [ k - 2 ] + {w}_{21} {h}_{2} [ k - 2 ] \\ {w}_{11} {h}_{1} [ k - 1 ] + {w}_{21} {h}_{2} [ k - 1 ]\end{matrix} ] = [ \begin{matrix}{h}_{1} [ k - 3 ] + {h}_{2} [ k - 3 ] \\ {h}_{1} [ k - 2 ] + {h}_{2} [ k - 2 ] \\ {h}_{1} [ k - 1 ] + {h}_{2} [ k - 1 ]\end{matrix} ] or \qquad ( 1 a )$$

$${h}_{p} = [ \begin{matrix}{w}_{12} {h}_{1} [ k - 3 ] + {w}_{22} {h}_{2} [ k - 3 ] \\ {w}_{12} {h}_{1} [ k - 2 ] + {w}_{22} {h}_{2} [ k - 2 ] \\ {w}_{12} {h}_{1} [ k - 1 ] + {w}_{22} {h}_{2} [ k - 1 ]\end{matrix} ] = [ \begin{matrix}{h}_{1} [ k - 3 ] - {h}_{2} [ k - 3 ] \\ {h}_{1} [ k - 2 ] - {h}_{2} [ k - 2 ] \\ {h}_{1} [ k - 1 ] - {h}_{2} [ k - 1 ]\end{matrix} ] \qquad ( 1 b )$$

A second vector gₚ that denotes the non-noisy observation at time step k+1 to k+L and corresponds to a precoded channel response that depends on the precoded weights is generated:

$${g}_{p} = [ \begin{matrix}{w}_{11} {h}_{1} [ k + 1 ] + {w}_{21} {h}_{2} [ k + 1 ] \\ {w}_{11} {h}_{1} [ k + 2 ] + {w}_{21} {h}_{2} [ k + 2 ] \\ {w}_{11} {h}_{1} [ k + 3 ] + {w}_{21} {h}_{2} [ k + 3 ]\end{matrix} ] = [ \begin{matrix}{h}_{1} [ k + 1 ] + {h}_{2} [ k + 1 ] \\ {h}_{1} [ k + 2 ] + {h}_{2} [ k + 2 ] \\ {h}_{1} [ k + 3 ] + {h}_{2} [ k + 3 ]\end{matrix} ] or \qquad ( 2 a )$$

$${g}_{p} = [ \begin{matrix}{w}_{12} {h}_{1} [ k + 1 ] + {w}_{22} {h}_{2} [ k + 1 ] \\ {w}_{12} {h}_{1} [ k + 2 ] + {w}_{22} {h}_{2} [ k + 2 ] \\ {w}_{12} {h}_{1} [ k + 3 ] + {w}_{22} {h}_{2} [ k + 3 ]\end{matrix} ] = [ \begin{matrix}{h}_{1} [ k + 1 ] - {h}_{2} [ k + 1 ] \\ {h}_{1} [ k + 2 ] - {h}_{2} [ k + 2 ] \\ {h}_{1} [ k + 3 ] - {h}_{2} [ k + 3 ]\end{matrix} ] \qquad ( 2 b )$$

At least one channel response hₙₚ at time step k is obtained, where hₙₚ does not depend on the precoded weights. This un-precoded channel response hₙₚ may be equal to the subchannel h₁ at this time step if it is mapped to the layer 1 and is noted:

$${h}_{np} = {h}_{1} [ k ] . \qquad ( 3 a )$$

or be equal to the subchannel h₂, if it mapped to the layer 2 and is noted:

$${h}_{np} = {h}_{2} [ k ] . \qquad ( 3 b )$$

The equalized noisy precoded observation made by the BS is h_{RX}:

$${h}_{RX} = {h}_{p} + {z}_{h}$$

where h_{RX} is the noisy channel observation corresponding to precoded channel vector hₚ and zₕ is a vector of the channel noise at time step k−1 to k−L.

Likewise, the equalized noisy precoded observation received by the BS is:

$${g}_{RX} = {g}_{p} + {z}_{g}$$

where g_{RX} is the noisy channel observation vector corresponding to precoded channel vector gₚ and z_{g} is a vector of the channel noise at time step k+1 to k+L.

Also the equalized noisy un-precoded observation made by the BS at time step k is:

$${h}_{rx} = {h}_{np} + {z}_{k}$$

where hₙₚ is the channel response corresponding to one or more un-precoded DMRSs signals.

A column vector z representing the additive noise is generated from zₕ, zₖ and z_{g}:

$$z = [ \begin{matrix}{z}_{h} \\ {z}_{k} \\ {z}_{g}\end{matrix} ]$$

The non-noisy input vector h is generated from hₚ, hₙₚ and gₚ:

$$h = [ \begin{matrix}{h}_{p} \\ {h}_{np} \\ {g}_{p}\end{matrix} ]$$

The noisy observation vector y is defined as:

$$y = [ \begin{matrix}{h}_{RX} \\ {h}_{rx} \\ {g}_{RX}\end{matrix} ] = [ \begin{matrix}{h}_{p} + {z}_{h} \\ {h}_{np} + {z}_{k} \\ {g}_{p} + {z}_{g}\end{matrix} ]$$

Furthermore, it holds

$${R}_{yy} = {R}_{hh} + {R}_{zz} \qquad ( 5 )$$

where R_{zz} is covariance matrix of the additive noise z, where the additive noise may be an Additive White Gaussian Noise (AWGN). Therefore the knowledge of the covariance matrix R_{zz} of the noise allows to compute the covariance matrix R_{yy} from Rₕₕ or vice versa.

For the concerned UE, the covariance matrix of this vector in time domain is computed as

$${R}_{hh} = E \{ [ \begin{matrix}{h}_{p} \\ {h}_{np} \\ {g}_{p}\end{matrix} ] [ \begin{matrix}{h}_{p}^{H} & {h}_{np}^{*} & {g}_{p}^{H}\end{matrix} ] \} = E \{ [ \begin{matrix}{h}_{p} {h}_{p}^{H} & {h}_{p} {h}_{np}^{*} & {h}_{p} {g}_{p}^{H} \\ {h}_{np} {h}_{p}^{H} & {\vert {h}_{np} \vert}^{2} & {h}_{np} {g}_{p}^{H} \\ {g}_{p} {h}_{p}^{H} & {g}_{p} {h}_{np}^{*} & {g}_{p} {g}_{p}^{H}\end{matrix} ] \} . \qquad ( 4 )$$

where E is the operator that returns an expectation of a statistical random variable;
where

$${h}_{p}^{H}$$

designates the Hermitian conjugate of hₚ;
where

$${h}_{np}^{*}$$

designates the conjugate of hₙₚ.

In equation (4), the vector multiplications

$${h}_{p} {h}_{p}^{H} , {h}_{p} {g}_{p}^{H} , {g}_{p} {h}_{p}^{H} and {g}_{p} {g}_{p}^{H}$$

represent the pure time domain correlation between the channel response vectors corresponding to precoded DMRS signals.

The operations

$${h}_{p} {h}_{np}^{*} , {h}_{np} {h}_{p}^{H} , {h}_{np} {g}_{p}^{H} and {g}_{p} {h}_{np}^{*}$$

represent the spatial correlation between the channel responses of precoded DMRS signals and the one or more un-precoded DMRS signals with respect to the uplink subchannels h₁ and h₂.

The ML-based model 600 is configured to receive as input the observation vector

$$y = [ \begin{matrix}{h}_{Rx} \\ {h}_{rx} \\ {g}_{Rx}\end{matrix} ] .$$

The ML-based model 600 includes a covariance computation block 601, an operator block 602, a neural network 603 and a channel estimation block 604.

The covariance computation block 601 is configured to compute the covariance matrix R_{yy} from the observation vector y. The operator block 602 (vec( )) is configured to stack all column vectors of the covariance matrix R_{yy} to a single column vector. The neural network 603 is configured to generate a channel estimation weighting matrix W from the vector vec(R_{yy}). The neural network 603 may be a DNN 500 as disclosed by reference to FIG. 5. The channel estimation block 604 is configured to generate the channel estimations from the channel estimation weighting matrix W by applying the channel estimation weighting matrix W to the observation vector

$$y = [ \begin{matrix}{h}_{Rx} \\ {h}_{rx} \\ {g}_{Rx}\end{matrix} ] .$$

$$[ \begin{matrix}\text{?} \\ {\hat{h}}_{np} \\ \text{?}\end{matrix} ] = W [ \begin{matrix}{h}_{Rx} \\ {h}_{rx} \\ {g}_{Rx}\end{matrix} ]$$

By feeding the sample covariance matrix R_{yy} to the neural network 603, the neural network 603 is configured to learn not only the time domain correlation but also the spatial domain correlation at transmitter side and exploit them for enhanced channel estimation. In training stage, the information on the precoding matrix is used for multiple precoding realizations as part of the labels for supervised learning. In inference stage, once the ML-based-model is well trained, then the precoding matrix can be transparent and the channel estimation can be done without any a priori information of the precoding matrix Wₓ.

The ML-based model 600 is configured to generate as output channel estimates. The channel estimates may include at least one channel estimate ĝ= [symbol] or respectively ĥ= [symbol] of precoded channel gₚ or respectively hₚ obtained from precoded DMRS. The channel estimates may include a channel estimate ĥₙₚ of the un-precoded channel hₙₚ, obtained from one or more un-precoded DMRSs signals.

In more generalized formulation, assume that the channel estimates Ĝ and Ĥ are:

$$\hat{G} = {W}_{p} G + {Z}_{G} \qquad ( 6 a )$$

$$and$$

$$\hat{H} = H + {Z}_{H} , \qquad ( 6 b )$$

where Wₚ denotes the L×L generalized precoding matrix, L is the number of transmitted layers in precoding, Z_{G} and Z_{H} are the L×S estimation error matrices, respectively.

The L×S matrix Ĝ represents the channel estimation of S precoded data signals: this channel estimation can be obtained at inference stage after exploiting the ML-based model to process the noisy precoded DMRS observation, sent through the radio channel.

The L×S matrix Ĥ represents the channel estimation of S un-precoded data signals: this channel estimation can be obtained at inference stage after exploiting the ML-based model to process the noisy un-precoded DMRS observation, sent through the radio channel.

During the inference phase, the precoded and un-precoded DMRSs received from a given UE are fed to a pre-trained neural network 603, which is configured to estimate/denoise both precoded DMRS and un-precoded DMRS precisely. The denoised un-precoded DMRS(s) can be exploited to monitor the sounding channel on relatively fast DMRS basis, and downlink operation can be executed in parallel, even without the available SRS. The channel estimations obtained from the un-precoded RS can serve as the most recently updated SRS to finetune the downlink performance.

In addition, from the algorithmic viewpoint, a BS can transparently exploit the ML-based model, without having to identify, whether user-specific SRS or un-precoded DMRS is transmitted. So the same ML-based model can be applied in the same manner to un-precoded SRS or un-precoded DMRS.

Furthermore, the channel estimates, obtained from the precoded DMRS and un-precoded RS, provide the possibility to estimate the UE adjusted uplink precoding matrix, which brings additional degrees of freedom to monitor and improve the downlink performance.

In one or more embodiments, the precoding matrix used by a UE may be estimated based on the precoded channel estimation Ĝ and the un-precoded channel estimation Ĥ. This can be performed at each time step or as necessary. A finite set of candidate precoding matrices may be used. The estimated precoding matrix Ŵₚ corresponds to the candidate precoding matrix Wᵢ of the finite set of candidate precoding matrices that minimizes the difference between the precoded channel estimation and a channel estimation resulting from the application of the concerned candidate precoding matrix to the un-precoded channel estimation:

$${\hat{W}}_{p} = arg {min}_{{W}_{i}} ‖ {W}_{i} \hat{H} - \hat{G} ‖ \qquad ( 7 )$$

For codebook-based precoding, the candidate precoding matrices come from the codebook. Part or all matrices defined by the codebook may be used.

Although equation (7) allows the BS to estimate the precoding matrix in codebook-based precoding mode, for non-codebook-based precoding, the same equation can be as well exploited. The set of candidate precoding matrices may be defined with a given resolution, for example including 256 matrices to reach target spatial resolution. This set may be defined based on one or more codebooks. By using equation (7), the estimated precoding matrix is the most likely one, which is closed to the non-codebook-based precoding matrix, freely selected by the user.

For non-codebook-based precoding, the BS may supplement the set of candidate precoding matrices by collecting the used precoding matrices reported by the user equipments.

The set of candidate precoding matrices may be completed over time by adding new candidate precoding matrices to refine the resolution of an initial set of candidate precoding matrices. For example, the best candidate precoding matrices of the initial set of candidate precoding matrices for which the quantity ∥WᵢĤ−Ĝ∥ is minimum may be identified and new candidate precoding matrices may be added to the initial set of candidate precoding matrices to refine the resolution of the initial set of candidate precoding matrices around the best candidate precoding matrices.

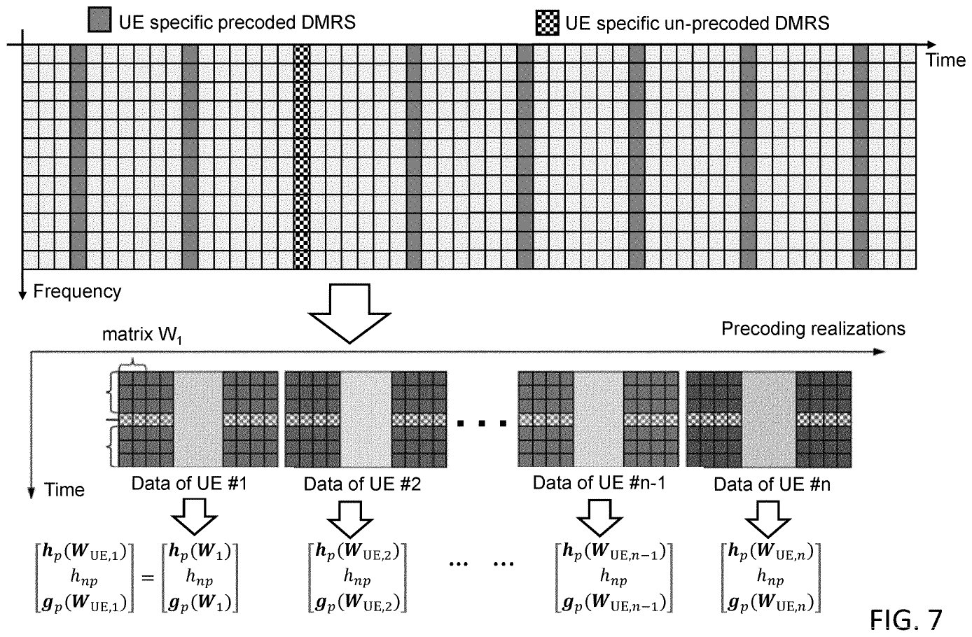

FIG. 7 illustrates the generation of signals for training the ML-based model 600 including the neural network 603.

For training, several sets of precoded DMRSs and un-precoded DMRSs signals from different user equipments are collected by a BS.

The (clean, not noisy DMRS) precoded and un-precoded DMRS signals may be collected for the precoding matrices used by various UE.

Due to the fact that the neural network 603 is trained for many precoding matrices, we can exhibit that the any arbitrarily exploited precoding matrix Wₓ will be transparent to the neural network 603 at inference stage.

For each UE a training column vector 803 is generated from the precoded DMRS signals obtained for time steps k−1 to k−L, the un-precoded DMRS at time step k and the precoded DMRS signals obtained for time steps k+1 to k+L:

$$[ \begin{matrix}{h}_{p} \\ {h}_{np} \\ {g}_{p}\end{matrix} ] 803$$

If several un-precoded DMRSs are used at input to the ML-based model, then hₙₚ will be a vector including these un-precoded DMRSs.

The DMRS signals of other UEs will be similarly processed with respect to their own precoding matrices to generate further training vectors. This may be repeated over time to collect several training vectors for each UE.

Also the precoded DMRS signals will be generated for all precoding matrices used over a time period. This allows to train the ML-based model for all candidate precoding matrices, such that any arbitrarily exploited precoding matrix exploited at inference time will be transparent to the ML-based model.

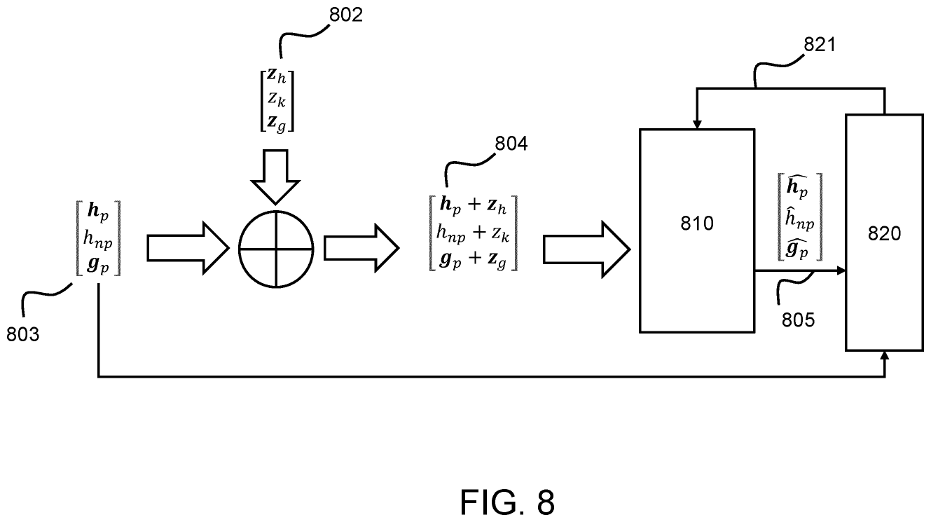

FIG. 8 illustrates the training of the ML-based model including the neural network 603.

A noise vector

$$[ \begin{matrix}{z}_{h} \\ {z}_{k} \\ {z}_{g}\end{matrix} ]$$

802 is added to each input training vector

$$[ \begin{matrix}{h}_{p} \\ {h}_{np} \\ {g}_{p}\end{matrix} ]$$

803 to generate an observation vector

$$[ \begin{matrix}{h}_{p} + {z}_{h} \\ {h}_{np} + {z}_{k} \\ {g}_{p} + {z}_{g}\end{matrix} ]$$

804. This allows to simulate various channel conditions, with different levels of noise. The additive noise (e.g. AWGN) may be a kind of variable noise to train the neural network 603, in order to make the neural network 603 later on be able to adapt to different SNR level at inference stage.

The observation vector

$$[ \begin{matrix}{h}_{p} + {z}_{h} \\ {h}_{np} + {z}_{k} \\ {g}_{p} + {z}_{g}\end{matrix} ]$$

804 is fed to the ML-based model 810 that generate as output the output channel estimates

$$[ \begin{matrix}\text{?} \\ {\hat{h}}_{np} \\ \text{?}\end{matrix} ]$$

805 using the learned NN parameters generates as output the output channel estimates to compute channel estimation weighting matrix W and then the channel estimates:

$$[ \begin{matrix}\text{?} \\ {\hat{h}}_{np} \\ \text{?}\end{matrix} ] = [ \begin{matrix}{h}_{p} + {z}_{h} \\ {h}_{np} + {z}_{k} \\ {g}_{p} + {z}_{g}\end{matrix} ]$$

At training stage, supervised learning may be used: the non-noisy input vector 803 may be used as “label” or reference vector (ideally with the knowledge of exploited precoding matrices and channel response), be compared by block 820 with the output channel estimates 805 generated by the ML-based model to generate an estimation error 821 that is used to adjust the weights of the neural network 603, used to generate a channel estimation weighting matrix, for each input observation vector 804 The channel estimation weighting matrix is then used to compute the channel estimates 805. The weights of the NN are adjusted to minimize the difference between the input vector 803 and channel estimates 805. When a convergence is reached, the pre-trained NN weights can be deployed at inference stage to compute a channel estimation weighting matrix in real-time, that will vary over time while the weights of the NN are fixed.

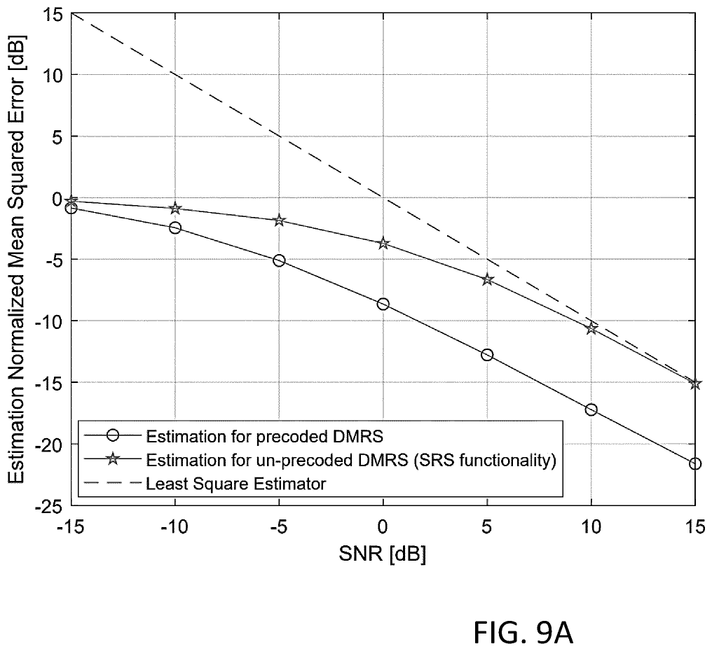

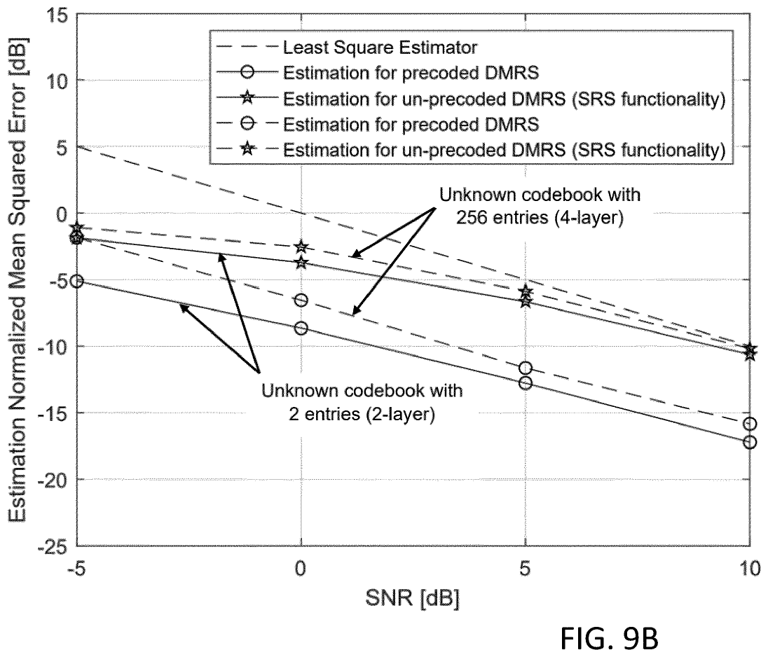

FIG. 9A shows the estimation Normalized Mean Squared Error (NMSE) as a function of the SNR of the radio channel according to an example.

Simulations have been here performed based on a system with three precoding matrix candidates as

$${W}_{0} = [ \begin{matrix}1 & 0 \\ 0 & 1\end{matrix} ] , {W}_{1} = [ \begin{matrix}1 & 1 \\ 1 & - 1\end{matrix} ] and {W}_{2} = [ \begin{matrix}1 & 1 \\ j & - j\end{matrix} ] .$$

A universal neural network 603 was trained to estimate the precoded channel and the un-precoded channel based on precoded DMRS(s) and un-precoded DMRS(s) that fulfill SRS functionality. The neural network 603 is trained for SNR between-20 dB to 20 dB, so that only one NN-model can universally support this SNR range. Since the time domain components are dominant in the covariance matrix Rₕₕ, the estimation of combined channels (by precoded DMRS) reaches very good estimation quality. By being able to jointly process precoded and un-precoded DMRS observations, the proposed ML-based solution can scalably exploit spatial domain correlation to benefit the un-precoded channel estimation. The scalable spatial domain correlation can be achieved by re-training the NN with increasing number of un-precoded DMRS components as the NN input. This makes the estimation outperform the Least Square (LS) bound, especially at low SNR. The least square bound corresponds to estimating the channel coefficients to reach the least value of the sum of squared errors, which is the noise variance as the residual errors in this case.

For other simulations, 16 basic precoding vectors were used to create a codebook with 2⁸=256 full-rank precoding matrices, for supporting 4-layer uplink transmission. On one side, more options in precoding give users additional degrees of freedom to better exploit the uplink spatial gain. On the other side, it is not straightforward to retrieve the precoding matrix anymore due to large number of candidate precoding matrices. But with the proposed NN-based solution, it was possible to solve this problem for a precoding scheme with a codebook with 256 entries.

In FIG. 9B, we compare the NMSE versus SNR performance for a precoding scheme with 2 precoding candidate matrices and another one with 256 precoding candidate matrices. Although slight performance loss can be observed, the case with 256 precoding candidate matrices serves as an example that demonstrate the possibility for jointly estimating the channel through both the precoded and un-precoded DMRS(s) in one NN, even without knowing which precoding matrix is selected out of 256 precoding candidate matrices.

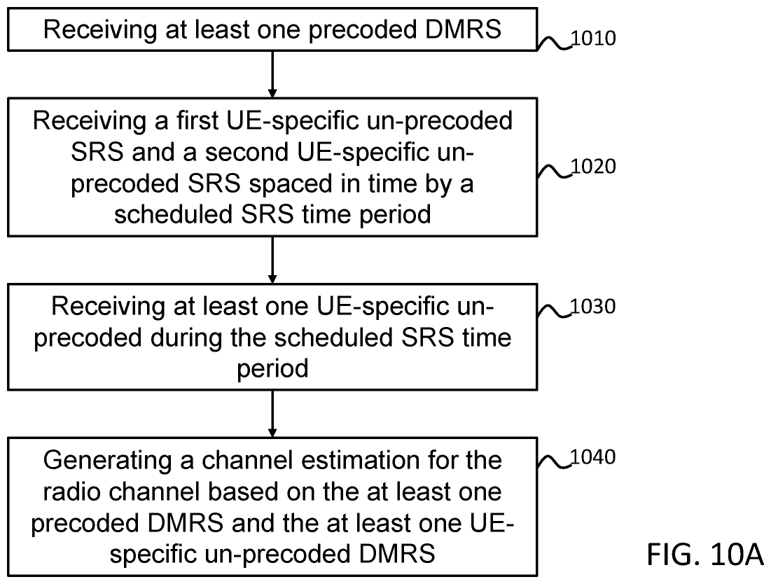

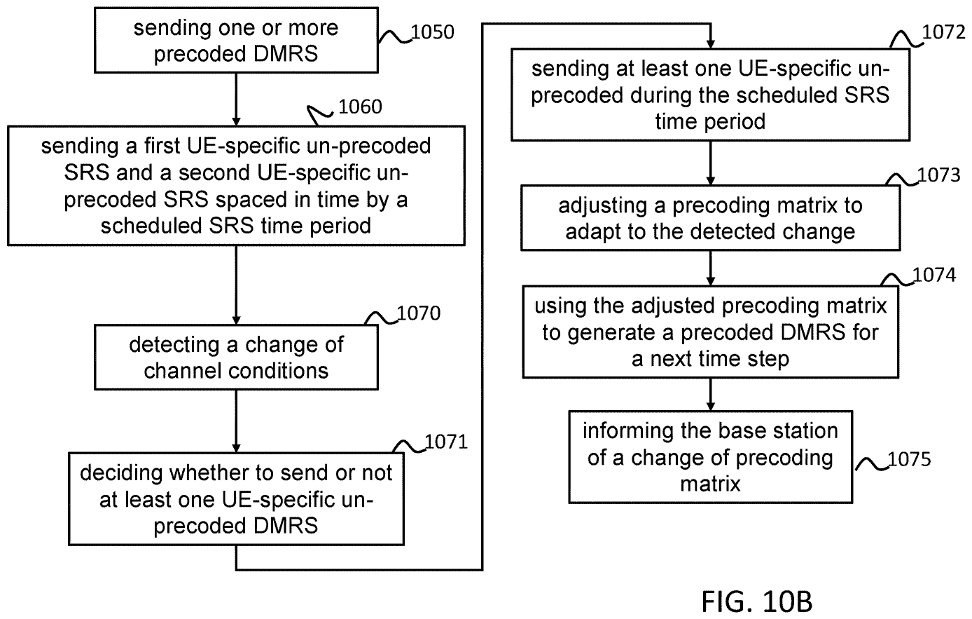

FIG. 10A shows a flowchart of a method for generating a channel estimation according to one or more example embodiments. The steps of the method may be implemented by an apparatus at base station side.

While the steps are described in a sequential manner, the man skilled in the art will appreciate that some steps may be omitted, combined, performed in different order and/or in parallel.

In step 1010, the base station receives, from a user equipment via a radio channel, at least one precoded Demodulated Reference Signal, DMRS.

In step 1020 the base station receives, from the UE via the radio channel, a first UE-specific un-precoded Sounding Reference Signal, SRS and a second UE-specific un-precoded SRS. The first UE-specific un-precoded SRS and the second UE-specific un-precoded SRS are spaced in time by a scheduled SRS time period.

In step 1030 the base station receives, from the UE via the radio channel and during the scheduled SRS period between the first and second UE-specific un-precoded SRS, at least one UE-specific un-precoded Demodulated Reference Signal, DMRS. The precoded DMRS and the un-precoded DMRS may be received during respective distinct time slots spaced in time with a same period.

In step 1030 the base station generates a channel estimation for the radio channel based on the at least one precoded DMRS and the at least one UE-specific un-precoded DMRS. Generating the channel estimation may include generating a precoded channel estimation and an un-precoded channel estimation.

Generating the channel estimation may be performed by a Machine Learning, ML, based model configured to generate the channel estimation using as inputs the precoded DMRSs and the at least one UE-specific un-precoded DMRS. The ML-based model may include a neural network.

Generating the channel estimation may be performed without a priori information on the precoding matrix used by the UE for generating the at least one precoded DMRS.

In step 1040 the base station estimates a precoding matrix used by the UE based on the precoded channel estimation and the un-precoded channel estimation.

The estimated precoding matrix may be selected in a finite set of candidate precoding matrices. The estimated precoding matrix may correspond to a candidate precoding matrix that minimizes the difference between the precoded channel estimation and a channel estimation resulting from the application of the concerned candidate precoding matrix to the un-precoded channel estimation.

FIG. 10B shows a flowchart of a method channel sounding according to one or more example embodiments. The steps of the method may be implemented by an apparatus at UE side.

While the steps are described in a sequential manner, the man skilled in the art will appreciate that some steps may be omitted, combined, performed in different order and/or in parallel.

In step 1050, the UE sends, to a base station via a radio channel, one or more precoded Demodulated Reference Signals, DMRSs.

In step 1060, the UE sends, to a base station via a radio channel, a first UE-specific un-precoded Sounding Reference Signals, SRS and a second UE-specific un-precoded SRS spaced in time by a scheduled SRS time period.

In step 1070, the UE detects a change of channel conditions at a current time step for the radio channel.

In step 1071, the UE decides dynamically whether to send or not at least one UE-specific un-precoded DMRS based on a frequency of the detected channel conditions changes.

In step 1072, the UE sends, to a base station, via a radio channel, during the scheduled SRS period between the first and second UE-specific un-precoded SRS, at least one UE-specific un-precoded Demodulated Reference Signal, DMRS.

In step 1073, the UE adjusts a precoding matrix configured by the base station to adapt to the detected change.

In step 1074, the UE uses the adjusted precoding matrix to generate a precoded DMRS for a next time step.

In step 1075, the UE informs the base station of a change of precoding matrix.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes.

Although a flow chart may describe operations as a sequential process, many of the operations may be performed in parallel, concurrently or simultaneously. Also some operations may be omitted, combined or performed in different order. A process may be terminated when its operations are completed but may also have additional steps not disclosed in the figure or description. A process may correspond to a method, function, procedure, subroutine, subprogram, etc. When a process corresponds to a function, its termination may correspond to a return of the function to the calling function or the main function.

Each described function, engine, block, step described herein can be implemented in hardware, software, firmware, middleware, microcode, or any suitable combination thereof.

When implemented in software, firmware, middleware or microcode, instructions to perform the necessary tasks may be stored in a computer readable medium that may be or not included in a host apparatus. The instructions may be transmitted over the computer-readable medium and be loaded onto the host apparatus. The instructions are configured to cause the host apparatus to perform one or more functions disclosed herein. For example, as mentioned above, according to one or more examples, at least one memory may include or store instructions, the at least one memory and the instructions may be configured to, with at least one processor, cause the host apparatus to perform the one or more functions. Additionally, the processor, memory and instructions, serve as means for providing or causing performance by the host apparatus of one or more functions disclosed herein.

The host apparatus may be a general-purpose computer and/or computing system, a special purpose computer and/or computing system, a programmable processing apparatus and/or system, a machine, etc. The host apparatus may be or include or be part of: a user equipment, client device, mobile phone, laptop, computer, network element, data server, network resource controller, network apparatus, router, gateway, network node, computer, cloud-based server, web server, application server, proxy server, etc.

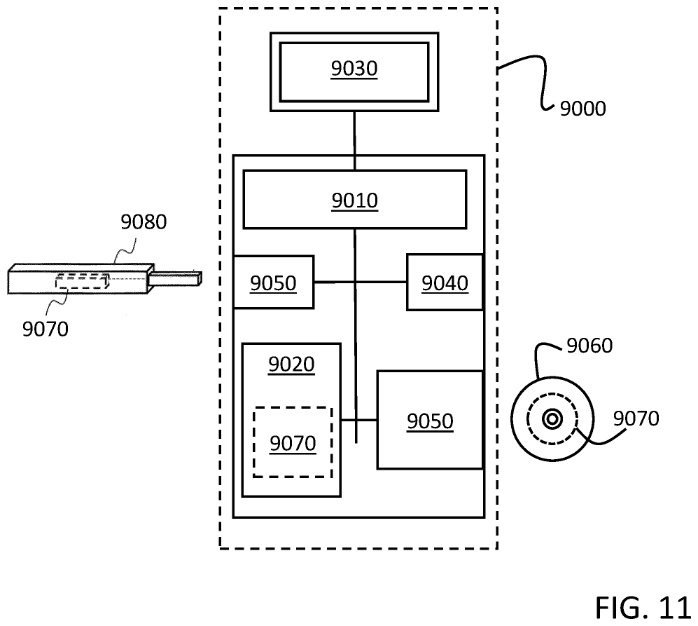

FIG. 11 illustrates an example embodiment of an apparatus 9000. The apparatus 9000 may be a host apparatus (e.g. a user equipment or a base station) or be hosted by a host apparatus (e.g. a user equipment or a base station) as disclosed herein. The apparatus 9000 may be used for performing one or more or all steps of any method disclosed herein.

As represented schematically by FIG. 11, the apparatus 9000 may include at least one processor 9010 and at least one memory 9020. The apparatus 9000 may include one or more communication interfaces 9040 (e.g. network interfaces for access to a wired/wireless network, including Ethernet interface, WIFI interface, etc) connected to the processor and configured to communicate via wired/non wired communication link(s). The apparatus 9000 may include user interfaces 9030 (e.g. keyboard, mouse, display screen, etc) connected with the processor. The apparatus 9000 may further include one or more media drives 9050 for reading a computer-readable storage medium (e.g. digital storage disc 9060 (CD-ROM, DVD, Blue Ray, etc), USB key 9080, etc). The processor 9010 is connected to each of the other components 9020, 9030, 9040, 9050 in order to control operation thereof.

The memory 9020 may include a random access memory (RAM), cache memory, non-volatile memory, backup memory (e.g., programmable or flash memories), read-only memory (ROM), a hard disk drive (HDD), a solid state drive (SSD) or any combination thereof. The ROM of the memory 9020 may be configured to store, amongst other things, an operating system of the apparatus 9000 and/or one or more computer program code of one or more software applications. The RAM of the memory 9020 may be used by the processor 9010 for the temporary storage of data.

The processor 9010 may be configured to store, read, load, execute and/or otherwise process instructions 9070 stored in a computer-readable storage medium 9060, 9080 and/or in the memory 9020 such that, when the instructions are executed by the processor, causes the apparatus 9000 to perform one or more or all steps of a method described herein for the concerned apparatus 9000.

The instructions may correspond to program instructions or computer program code. The instructions may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), an arithmetic logic unit (ALU), a programmable logic unit (PLU), a processing core, a programmable logic, a microprocessor, a controller, a microcontroller, a microcomputer, a quantum processor, any device capable of responding to and/or executing instructions in a defined manner and/or according to a defined logic. Other hardware, conventional or custom, may also be included. A processor or processing circuit may be configured to execute instructions adapted for causing the host apparatus to perform one or more functions disclosed herein for the host apparatus.

A computer readable medium or computer readable storage medium may be any tangible storage medium suitable for storing instructions readable by a computer or a processor. A computer readable medium may be more generally any storage medium capable of storing and/or containing and/or carrying instructions and/or data. The computer readable medium may be a non-transitory computer readable medium. The term “non-transitory”, as used herein, is a limitation of the medium itself (i.e., tangible, not a signal) as opposed to a limitation on data storage persistency (e.g., RAM vs. ROM).

A computer-readable medium may be a portable or fixed storage medium. A computer readable medium may include one or more storage device like a permanent mass storage device, magnetic storage medium, optical storage medium, digital storage disc (CD-ROM, DVD, Blue Ray, etc), USB key or dongle or peripheral, a memory suitable for storing instructions readable by a computer or a processor.

A memory suitable for storing instructions readable by a computer or a processor may be for example: read only memory (ROM), a permanent mass storage device such as a disk drive, a hard disk drive (HDD), a solid state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more devices”, “one or more units”, etc. The means may include at least one processor and at least one memory including computer program code, wherein the at least one memory and the computer program code are configured to, with the at least one processor, cause an apparatus or system to perform the concerned function(s).

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit for a network element or network node or any other computing device or network device.

The term circuitry may cover digital signal processor (DSP) hardware, network processor, application specific integrated circuit (ASIC), field programmable gate array (FPGA), etc. The circuitry may be or include, for example, hardware, programmable logic, a programmable processor that executes software or firmware, and/or any combination thereof (e.g. a processor, control unit/entity, controller) to execute instructions or software and control transmission and receptions of signals, and a memory to store data and/or instructions.

The circuitry may also make decisions or determinations, generate frames, packets or messages for transmission, decode received frames or messages for further processing, and other tasks or functions described herein. The circuitry may control transmission of signals or messages over a radio network, and may control the reception of signals or messages, etc., via one or more communication networks.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

While aspects of the present disclosure have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present disclosure as determined based upon the claims and any equivalents thereof.

### List of Main Abbreviations

AWGN Additive White Gaussian Noise
BS Base Station
CSI Channel State Information
DMRS Demodulation Reference Signal
DNN Dense Neural Network
LS Least Square
ML Machine Learning
NMSE Normalized Mean Squared Error
NN Neural Network
NR New Radio
PHY PHYsical layer
PUCCH Physical Uplink Control Channel
PUSCH Physical Uplink Shared Channel
RS Reference Signal
SIP Standard Implementation Patent
SEP Standard Essential Patent
SNR Signal-to-Noise Ratio
SRS Sounding Reference Signal
UE User Equipment

1. A method comprising:
receiving, from a user equipment, UE, by a base station, via a radio channel, precoded Demodulated Reference Signals, DMRSs;
receiving, from the UE by the base station, via the radio channel, a first UE-specific un-precoded Sounding Reference Signal, SRS and a second UE-specific un-precoded SRS spaced in time by a scheduled SRS time period;
receiving, from the UE by the base station, via the radio channel and during the scheduled SRS period between the first and second UE-specific un-precoded SRS, at least one UE-specific un-precoded Demodulated Reference Signal, DMRS;
generating a channel estimation for the radio channel based on the at least one precoded DMRS and the at least one UE-specific un-precoded DMRS, wherein the DMRSs and the at least one UE-specific un-precoded DMRS are received during respective distinct time slots spaced in time with a same period.

2. (canceled)

3. The method of claim 1, wherein generating the channel estimation includes generating a precoded channel estimation and an un-precoded channel estimation.

4. The method of claim 1, wherein generating the channel estimation is performed by a Machine Learning, ML, based model configured to generate the channel estimation using as inputs the precoded DMRSs and the at least one UE-specific un-precoded DMRS.

5. The method of claim 4, wherein the ML based model is a neural network.

6. The method of claim 3, wherein generating the channel estimation is performed without a priori information on the precoding matrix used by the UE for generating the precoded DMRSs.

7. The method of claim 3, comprising: estimating a precoding matrix used by the UE based on the precoded channel estimation and the un-precoded channel estimation.

8. The method of claim 7, wherein the estimated precoding matrix is selected in a finite set of candidate precoding matrices and corresponds to a candidate precoding matrix that minimizes the difference between the precoded channel estimation and a channel estimation resulting from the application of the concerned candidate precoding matrix to the un-precoded channel estimation.

9-11. (canceled)

12. An apparatus comprising at least one processor and at least one memory storing instructions that, when executed by the at least one processor, cause the apparatus to:
receive, from a user equipment, UE, by a base station, via a radio channel, precoded Demodulated Reference Signals, DMRSs;
receive, from the UE by the base station, via the radio channel, a first UE-specific un-precoded Sounding Reference Signal, SRS and a second UE-specific un-precoded SRS spaced in time by a scheduled SRS time period;
receive, from the UE by the base station, via the radio channel and during the scheduled SRS period between the first and second UE-specific un-precoded SRS, at least one UE-specific un-precoded Demodulated Reference Signal, DMRS;
generate a channel estimation for the radio channel based on the at least one precoded DMRS and the at least one UE-specific un-precoded DMRS, wherein the DMRSs and the at least one UE-specific un-precoded DMRS are received during respective distinct time slots spaced in time with a same period.

13. (canceled)

14. A computer program comprising instructions for causing an apparatus to perform a method comprising:
receiving, from a user equipment, UE, by a base station, via a radio channel, precoded Demodulated Reference Signals, DMRSs;
receiving, from the UE by the base station, via the radio channel, a first UE-specific un-precoded Sounding Reference Signal, SRS and a second UE-specific un-precoded SRS spaced in time by a scheduled SRS time period;
receiving, from the UE by the base station, via the radio channel and during the scheduled SRS period between the first and second UE-specific un-precoded SRS, at least one UE-specific un-precoded Demodulated Reference Signal, DMRS;
generating a channel estimation for the radio channel based on the at least one precoded DMRS and the at least one UE-specific un-precoded DMRS, wherein the DMRSs and the at least one UE-specific un-precoded DMRS are received during respective distinct time slots spaced in time with a same period.

15. (canceled)
